(19) United States
(12) Patent Application Publication
(10) Pub. No.: US 2025/0223223 A1
(43) Pub. Date: Jul. 10, 2025

(54) PREPARATION METHOD OF SUPPLEMENTARY CEMENTITIOUS MATERIAL BASED ON ELECTROSTATIC ADSORPTION FOR HIGH-EFFICIENCY CO2 SEQUESTRATION

(71) Applicant: Shandong University, Jinan (CN)

(72) Inventors: Hongzhi ZHANG, Jinan (CN); Jiahui MEN, Jinan (CN); Zhi GE, Jinan (CN); Shengya ZHOU, Jinan (CN); Yujie FENG, Jinan (CN); Hanming ZHANG, Jinan (CN); Xingjie XUE, Jinan (CN)

(21) Appl. No.: 19/008,979

(22) Filed: Jan. 3, 2025

(30) Foreign Application Priority Data
Jan. 8, 2024 (CN) 202410025232.6

(51) Int. Cl. C04B 7/153; C04B 7/26; C04B 111/00

(52) U.S. Cl. CPC C04B 7/153; C04B 7/26; C04B 2111/00017; C04B 2111/00215

(57) ABSTRACT

A preparation method of a supplementary cementitious material based on electrostatic adsorption for high-efficiency CO₂ sequestration is provided. The preparation method of the present disclosure includes the following steps: placing ultrafine carbide slag powder into an electrostatic field to make the ultrafine carbide slag powder have electrostatic charge, and obtaining ultrafine carbide slag powder with electrostatic charge; and uniformly mixing low-calcium fly ash and the ultrafine calcium carbide slag powder with electrostatic charge, followed by adding into a rotary packed bed; continuously introducing industrial waste gas containing CO₂ and water vapor into the rotary packed bed; after a reaction, collecting a material and drying to obtain the supplementary cementitious material based on electrostatic adsorption for high-efficiency CO₂ sequestration.

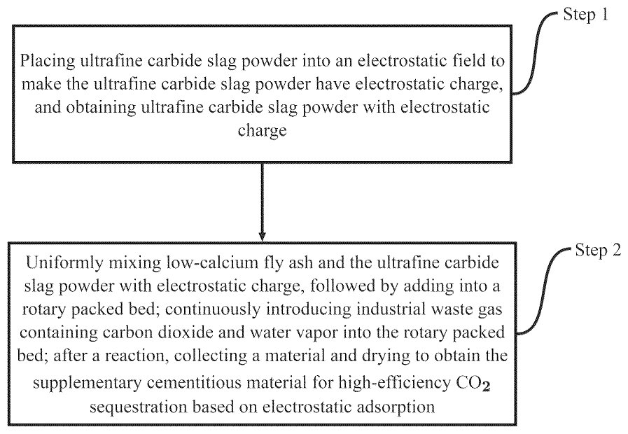

### CROSS-REFERENCE TO RELATED APPLICATIONS

This application claims priority to Chinese Patent Application No. 202410025232.6, filed on Jan. 8, 2024, the contents of which are hereby incorporated by reference.

### TECHNICAL FIELD

The present disclosure relates to a preparation method of a supplementary cementitious material based on electrostatic adsorption for high-efficiency CO₂ sequestration, and belongs to the technical field of building materials.

### BACKGROUND

CO₂ emission in the cement industry is high and there is therefore an urgent need to develop low-carbon cementitious materials to replace cement.

Fly ash is a by-product of coal-fired power plants; unused fly ash is stored in landfills, which may pollute water sources and soil if not handled properly. The production of acetylene by the calcium carbide method produces calcium carbide slag, and the stockpiling of calcium carbide slag occupies a large amount of land, causes pollution of water resources, and affects the surrounding ecological environment. The CO₂ emission, one of the most important greenhouse gases, is in urgent need of effective control. However, existing CO₂ sequestration methods have problems such as low efficiency, high energy consumption, low CO₂ sequestration efficiency and long production time. Chinese patent document CN104759203A discloses a fluidized bed process for directly capturing and sequestrating CO₂ in flue gas, using high-calcium waste such as fly ash as raw material, opening a bypass on the flue gas discharge flue to lead a stream of flue gas through the temperature and humidity regulator to adjust the temperature and humidity, and then contacting the flue gas after temperature and humidity regulation and the high-calcium waste side by side to react to generate calcium carbonate in a fluidized bed reactor, then sending the dusty gas out of the reactor into a cyclone separator for gas-solid separation, and sending the obtained gas back to the original flue gas emission flue to be discharged into a chimney. The process of the CN104759203A not only effectively improves the utilization of fly ash, but also reduces CO₂ emissions from the power plant; however, the solid waste involved in the reaction in the invention is single, and the utilization rate of the solid waste is low. Chinese patent document CN101219330A discloses a process method and a device thereof for in-situ CO₂ sequestration in flue gas with integrated coupling of CO₂ absorption and separation, carbonation sequestration, and solid waste resource utilization of multi-processes; a supergravity rotating packed-bed reactor is used, which greatly improves the rate of CO₂ mass-transfer and absorption. However, in this invention, calcium carbonate products are prepared only by carbonation reaction, and the solid waste residue after Ca²⁺ leaching is still discarded, failing to fully utilize the solid waste.

### SUMMARY

Aiming at the shortcomings of the prior art, the present disclosure provides a preparation method of a supplementary cementitious material based on electrostatic adsorption for high-efficiency CO₂ sequestration. The supplementary cementitious material is obtained by using calcium slag as a calcium source and low-calcium fly ash as a calcium source and matrix, with calcium slag particles adsorbed on a surface of fly ash particles by electrostatic adsorption, and prepared by carbonization reaction with CO₂-containing industrial flue gas with a certain humidity in a rotary packed-bed equipment. In the method provided by the present disclosure, the raw materials are cheap and easy to obtain, with high efficiency and low energy consumption, the CO₂ in industrial waste gas may be sequestered permanently, and the amount of CO₂ sequestered as well as the efficiency of sequestering are high, realizing the highly resourceful reuse of waste materials such as fly ash. The obtained supplementary cementitious material is compounded with cement to obtain a cementitious system with higher strength and faster setting time, which is expected to replace more cement clinker in the preparation of low-carbon composite cement.

In order to achieve the above objective, the technical schemes of the present disclosure are as follows.

The present disclosure relates to a preparation method of a supplementary cementitious material based on electrostatic adsorption for high-efficiency CO₂ sequestration, including:
step 1, placing ultrafine carbide slag powder into an electrostatic field to make the ultrafine carbide slag powder have electrostatic charge, and obtaining ultrafine carbide slag powder with electrostatic charge; and
step 2, uniformly mixing low-calcium fly ash and the ultrafine calcium carbide slag powder with electrostatic charge, followed by adding into a rotary packed bed; continuously introducing industrial waste gas containing CO₂ and water vapor into the rotary packed bed; after a reaction, collecting a material and drying to obtain the supplementary cementitious material based on electrostatic adsorption for high-efficiency CO₂ sequestration.

In an embodiment of the present disclosure, in the step 1, a particle size of the ultrafine carbide slag powder is 1000-2500 meshes; and the ultrafine carbide slag powder is prepared by drying and grinding carbide slag.

In an embodiment of the present disclosure, in the step 1, the ultrafine carbide slag powder includes the following components in parts by mass: 86.26-89.21 parts of CaO, 3.12-5.41 parts of SiO₂, 4.01-6.75 parts of SO₃, 1.39-2.27 parts of Al₂O₃ and 0.21-1.97 parts of MgO.

In an embodiment of the present disclosure, in the step 1, the electrostatic field is generated by a discharger, where a high-voltage rectifier converts 220 volts (V) alternating current into a high-voltage direct current, and an air is ionized to produce a large number of free electrons, which are attached to a surface of the ultrafine carbide slag powder to make it electrically charged.

In an embodiment of the present disclosure, in the step 2, the low-calcium fly ash is solid waste generated by coal-fired power plants; and a particle size of the low-calcium fly ash is 150-500 meshes.

In an embodiment of the present disclosure, in the step 2, the low-calcium fly ash includes the following components in parts by mass: 2.32-3.76 parts of CaO, 44.01-57.89 parts of SiO₂, 23.24-31.34 parts of Fe₂O₃, 2.27-5.15 parts of Fe₂O₃ and 0.63-3.97 parts of MgO.

In an embodiment of the present disclosure, in the step 2, a mass ratio of the low-calcium fly ash to the ultrafine carbide slag powder with electrostatic charge is 60-90:10-30.

In an embodiment of the present disclosure, in the step 2, in a process of the mixing, the ultrafine carbide slag powder with electrostatic charge produces an electrostatic adsorption effect so as to make the ultrafine carbide slag powder adsorbed with the low-calcium fly ash particles, and the calcium carbide slag is uniformly adhered to the surface of the fly ash.

In an embodiment of the present disclosure, in the step 2, a continuous flow rate of the industrial waste gas containing CO₂ and water vapor is 3-5 liters per minute (L/min).

In an embodiment of the present disclosure, in the step 2, the industrial waste gas containing CO₂ and water vapor includes the following components in percentage by volume: 9-10% of water vapor, 25-26% of CO₂ and 60-61% of nitrogen; optionally, the industrial waste gas containing CO₂ and water vapor includes the following components in percentage by volume: 9.6% of water vapor, 25.4% of CO₂ and 60.5% of nitrogen.

In an embodiment of the present disclosure, in the step 2, a duration of the reaction is 5-15 min, preferably 10 min; a rotating speed of the rotary packed bed is 300-500 r/min, preferably 500 r/min; and a temperature of the rotary packed bed is 20-30 degrees Celsius (° C.) and a pressure is 0.05-0.5 megapascal (MPa).

A supplementary cementitious material based on electrostatic adsorption for high-efficiency CO₂ sequestration prepared by the above preparation method.

A use method of the supplementary cementitious material based on electrostatic adsorption for high-efficiency CO₂ sequestration in concrete and/or mortar.

According to the present disclosure, the supplementary cementitious material based on electrostatic adsorption for high-efficiency CO₂ sequestration is compounded with cement and then applied to concrete and/or mortar; optionally, a mass ratio of the supplementary cementitious material based on electrostatic adsorption for high-efficiency CO₂ sequestration is 20-40:60-80. The cementitious material of the present disclosure may replace part of the cement used, thus reducing the carbon footprint of the cement industry and mitigating the impact of greenhouse gases on the environment. Meanwhile, the nano-calcium carbonate generated by the carbonation reaction may accelerate the hydration of the cement and enhance the early strength of the cementitious material.

The principle of the present disclosure is as follows.

The carbonation reaction involves a series of physical and chemical processes, which are roughly divided into four stages based on the gas-liquid-solid three-phase reaction theory. First of all, the water vapor in the industrial waste gas provides a liquid environment for the carbonation reaction. The calcium-based active substances in the calcium slag and fly ash dissolve and undergo hydrolysis in the water, releasing hydroxide ions, which increases the pH value of the slurry, and the slurry exhibits a strong alkalinity that efficiently captures the CO₂ in the industrial waste gas; the CO₂ in the industrial waste gas dissolves in water to form carbonic acid, which reacts rapidly with hydroxide and calcium ions in the slurry, causing the pH value of the slurry to begin to fall and generating calcium carbonate precipitation; as the mineralization reaction continues, the rate of hydrolysis to produce hydroxide ions is gradually lower than the rate of CO₂ flux to produce hydrogen ions, and when the pH value of the slurry is gradually reduced to 7 and remain unchanged, the carbonation reaction is basically completed.

CaO+H₂O═Ca(OH)₂

Ca(OH)₂=Ca²⁺+2OH⁻

CO₂+H₂⁺ [symbol] H₂CO₃

H₂CO₃ [symbol] H⁺+HCO₃⁻

CO₂+OH [symbol] HCO₃⁻

HCO₃ [symbol] CO₃²⁻+H⁺

Ca²⁺+CO₃²⁻═CaCO₃

The present disclosure has the following technical characteristics and beneficial effects.

The present disclosure adopts industrial solid wastes such as fly ash and carbide slag as the raw materials, which are cheap and easily available, thus realizing efficient resource reuse of fly ash and carbide slag. The small particle size of the raw material facilitates the subsequent electrostatic adsorption and reaction, which is conducive to the utilization of its filling effect. Ultrafine particles may improve the packing density of cement cementitious system, replace the pore water between particles, and increase the free water content for hydration reaction; the nano-calcium carbonate generated in the process of carbonation may fill the pore space of the cement matrix to make the structure more dense, and at the same time, provide more nucleation sites for the cement hydration to accelerate the hydration, and the early strength and durability of the cement are also improved.

In the present disclosure, calcium carbide slag is used as a calcium source, and low-calcium fly ash is used as a calcium source and a matrix; calcium carbide slag particles are electrostatically adsorbed onto the surface of fly ash particles, and carbonized with industrial flue gas containing CO₂ with a certain humidity in a rotary packed bed device to prepare a supplementary cementitious material. Calcium carbide slag particles are adsorbed on fly ash particles by electrostatic action, which reduces the time of ion diffusion, and at the same time prevents the generated calcium carbonate from agglomerating on the surface of calcium carbide slag to hinder the precipitation of internal ions, improves the reaction efficiency and CO₂ sequestration capacity, and improves the compressive strength of supplementary cementitious materials and cement-based cementitious systems. Fly ash is spherical, and calcium carbonate generated by carbide slag carbonization partially adheres to the surface of fly ash, which may reduce the side effects of nano-materials on the workability of cement when added to cement with fly ash. By the material and chemical action of calcium carbonate nanoparticles, the hydration of cement is accelerated, and the side effects of fly ash on cement setting time and on early strength are alleviated. If the calcium carbide slag is not electrostatically treated, the reaction rate is slow, the carbonation efficiency and CO₂ sequestration are low, the resulting supplementary cementitious material has a significant reduction in cement workability, and contributes less to the acceleration of setting and the development of strength of the composite cement material.

In the present disclosure, a rotary packed bed is used as a reactor to increase gas-liquid mass transfer through high centrifugal acceleration, and the carbonation reaction counter rate is greatly improved.

The method of the present disclosure is preferably aimed at the calcium carbide slag powder and low-calcium fly ash with specific composition of the present disclosure. If the composition is inappropriate, the CO₂ sequestration capacity, the compressive strength of the obtained supplementary cementitious material and the cement-based cementitious system will be reduced. The particle size of calcium carbide slag powder needs to be appropriate, if not, the performance of CO₂ sequestration, the resulting supplementary cementitious material and the compressive strength of the cement-based cementitious system will also be reduced. The mass ratio of low-calcium fly ash to ultrafine carbide slag powder with electrostatic charge, the rotating speed, temperature and pressure of the rotary packed bed need to be appropriate, and if not, the above excellent effects of the present disclosure may not be achieved. The method of the present disclosure works as a whole, with the steps and conditions interacting together to achieve the excellent results of the disclosure.

The method of the present disclosure allows permanent sequestration of CO₂ from industrial exhaust gases, with high CO₂ sequestration amount as well as sequestration efficiency; and the preparation process is mild in reaction conditions, consumes less energy and is highly efficient, with no emission of exhaust gases and less water consumption, which is beneficial to slowing down global warming and protecting the environment. The cementitious material obtained by the present disclosure has high compressive strength and other mechanical properties, and is expected to be used as a low-carbon cementitious material to replace cement; the cementitious material obtained by the present disclosure is compounded with cement to effectively improve the compressive strength and other mechanical properties of the cement-based cementitious system, with faster setting time, which is expected to replace more cement clinker in the preparation of low-carbon composite cement.

### BRIEF DESCRIPTION OF THE DRAWINGS

The FIGURE is a process illustrating a preparation method of a supplementary cementitious material based on electrostatic adsorption for high-efficiency CO₂ sequestration provided by the present disclosure.

### DETAILED DESCRIPTION OF THE EMBODIMENTS

In order to make the technical problems, technical solutions and advantages to be solved by the present disclosure clearer, the following will be described in detail with specific embodiments, but not limited to this. Anything not described in detail in the present disclosure shall follow the conventional technology in this field.

The present disclosure relates to a preparation method of a supplementary cementitious material based on electrostatic adsorption for high-efficiency CO₂ sequestration, including following steps as shown in the FIGURE:
step 1, placing ultrafine carbide slag powder into an electrostatic field to make the ultrafine carbide slag powder have electrostatic charge, and obtaining ultrafine carbide slag powder with electrostatic charge; and
step 2, uniformly mixing low-calcium fly ash and the ultrafine calcium carbide slag powder with electrostatic charge, followed by adding into a rotary packed bed; continuously introducing industrial waste gas containing CO₂ and water vapor into the rotary packed bed; after a reaction, collecting a material and drying to obtain the supplementary cementitious material based on electrostatic adsorption for high-efficiency CO₂ sequestration.

In the embodiments, the ultrafine carbide slag powder includes the following components in percentage by mass: CaO 88.10%, SiO₂ 3.51%, SO₃ 5.77%, Al₂O₃1.91% and MgO 0.35%.

The low-calcium fly ash includes the following components in percentage by mass: CaO 2.56 wt %, SiO₂ 57.25 wt %, Al₂O₃23.24 wt %, Fe₂O₃ 5.02 wt % and MgO 1.97 wt %.

The industrial waste gas containing CO₂ and water vapor includes the following components by volume: 9.6% of water vapor, 25.4% of CO₂, 60.5% of nitrogen and 4.5% of other components.

### Embodiment 1

The present disclosure relates to a preparation method of a supplementary cementitious material based on electrostatic adsorption for high-efficiency CO₂ sequestration, which includes the following steps:
(1) oven drying and grinding carbide slag to obtain ultrafine carbide slag powder with 1000 meshes, and placing the ultrafine carbide slag powder in an electrostatic field generated by a discharge mechanism to make it electrostatically charged to obtain ultrafine carbide slag powder with electrostatic charge;
(2) mixing low-calcium fly ash (150-500 meshes) with the ultrafine carbide slag powder with electrostatic charge in a mixer for 5 min, making the carbide slag uniformly attached to the surface of the fly ash, where the mass ratio of the low-calcium fly ash to the ultrafine carbide slag powder with electrostatic charge is 80:20, and the mixture enters a rotary packed bed through a feed port, and the ultrafine carbide slag powder with electrostatic charge is adsorbed with low-calcium fly ash particles by electrostatic adsorption;
(3) continuously introducing industrial waste gas containing CO₂ and water vapor into the rotary packed bed, controlling the flow rate to be 4 L/min, and starting the rotating device, where the rotating speed is 300 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the supplementary cementitious material based on electrostatic adsorption for high-efficiency CO₂ sequestration.

### Embodiment 2

A preparation method of a supplementary cementitious material based on electrostatic adsorption for high-efficiency CO₂ sequestration, including the following steps:
(1) oven drying and grinding carbide slag to obtain ultrafine carbide slag powder with 1000 meshes, and placing the ultrafine carbide slag powder in an electrostatic field generated by a discharge mechanism to make it electrostatically charged to obtain ultrafine carbide slag powder with electrostatic charge;
(2) mixing low-calcium fly ash (150-500 meshes) with the ultrafine carbide slag powder with electrostatic charge in a mixer for 5 min, making the carbide slag uniformly attached to the surface of the fly ash, where the mass ratio of the low-calcium fly ash to the ultrafine carbide slag powder with electrostatic charge is 80:20, and the mixture enters a rotary packed bed through a feed port, and the ultrafine carbide slag powder with electrostatic charge is adsorbed with low-calcium fly ash particles by electrostatic adsorption;
(3) continuously introducing industrial waste gas containing CO₂ and water vapor into the rotary packed bed, controlling the flow rate to be 4 L/min, and starting the rotating device, where the rotating speed is 400 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the supplementary cementitious material based on electrostatic adsorption for high-efficiency CO₂ sequestration.

### Embodiment 3

A preparation method of a supplementary cementitious material based on electrostatic adsorption for high-efficiency CO₂ sequestration, which includes the following steps:
(1) oven drying and grinding carbide slag to obtain ultrafine carbide slag powder with 1000 meshes, and placing the ultrafine carbide slag powder in an electrostatic field generated by a discharge mechanism to make it electrostatically charged to obtain ultrafine carbide slag powder with electrostatic charge;
(2) mixing low-calcium fly ash (150-500 meshes) with the ultrafine carbide slag powder with electrostatic charge in a mixer for 5 min, making the carbide slag uniformly attached to the surface of the fly ash, where the mass ratio of the low-calcium fly ash to the ultrafine carbide slag powder with electrostatic charge is 80:20, and the mixture enters a rotary packed bed through a feed port, and the ultrafine carbide slag powder with electrostatic charge is adsorbed with low-calcium fly ash particles by electrostatic adsorption;
(3) continuously introducing industrial waste gas containing CO₂ and water vapor into the rotary packed bed, controlling the flow rate to be 4 L/min, and starting the rotating device, where the rotating speed is 500 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the supplementary cementitious material based on electrostatic adsorption for high-efficiency CO₂ sequestration.

### Embodiment 4

A preparation method of a supplementary cementitious material based on electrostatic adsorption for high-efficiency CO₂ sequestration, which includes the following steps:
(1) oven drying and grinding carbide slag to obtain ultrafine carbide slag powder with 1500 meshes, and placing the ultrafine carbide slag powder in an electrostatic field generated by a discharge mechanism to make it electrostatically charged to obtain ultrafine carbide slag powder with electrostatic charge;
(2) mixing low-calcium fly ash (150-500 meshes) with the ultrafine carbide slag powder with electrostatic charge in a mixer for 5 min, making the carbide slag uniformly attached to the surface of the fly ash, where the mass ratio of the low-calcium fly ash to the ultrafine carbide slag powder with electrostatic charge is 80:20, and the mixture enters a rotary packed bed through a feed port, and the ultrafine carbide slag powder with electrostatic charge is adsorbed with low-calcium fly ash particles by electrostatic adsorption;
(3) continuously introducing industrial waste gas containing CO₂ and water vapor into the rotary packed bed, controlling the flow rate to be 4 L/min, and starting the rotating device, where the rotating speed is 500 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the supplementary cementitious material based on electrostatic adsorption for high-efficiency CO₂ sequestration.

### Embodiment 5

A preparation method of a supplementary cementitious material based on electrostatic adsorption for high-efficiency CO₂ sequestration, which includes the following steps:
(1) oven drying and grinding carbide slag to obtain ultrafine carbide slag powder with 2000 meshes, and placing the ultrafine carbide slag powder in an electrostatic field generated by a discharge mechanism to make it electrostatically charged to obtain ultrafine carbide slag powder with electrostatic charge;
(2) mixing low-calcium fly ash (150-500 meshes) with the ultrafine carbide slag powder with electrostatic charge in a mixer for 5 min, making the carbide slag uniformly attached to the surface of the fly ash, where the mass ratio of the low-calcium fly ash to the ultrafine carbide slag powder with electrostatic charge is 80:20, and the mixture enters a rotary packed bed through a feed port, and the ultrafine carbide slag powder with electrostatic charge is adsorbed with low-calcium fly ash particles by electrostatic adsorption;
(3) continuously introducing industrial waste gas containing CO₂ and water vapor into the rotary packed bed, controlling the flow rate to be 4 L/min, and starting the rotating device, where the rotating speed is 500 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the supplementary cementitious material based on electrostatic adsorption for high-efficiency CO₂ sequestration.

### Embodiment 6

A preparation method of a supplementary cementitious material based on electrostatic adsorption for high-efficiency CO₂ sequestration, which includes the following steps:
(1) oven drying and grinding carbide slag to obtain ultrafine carbide slag powder with 2500 meshes, and placing the ultrafine carbide slag powder in an electrostatic field generated by a discharge mechanism to make it electrostatically charged to obtain ultrafine carbide slag powder with electrostatic charge;
(2) mixing low-calcium fly ash (150-500 meshes) with the ultrafine carbide slag powder with electrostatic charge in a mixer for 5 min, making the carbide slag uniformly attached to the surface of the fly ash, where the mass ratio of the low-calcium fly ash to the ultrafine carbide slag powder with electrostatic charge is 80:20, and the mixture enters a rotary packed bed through a feed port, and the ultrafine carbide slag powder with electrostatic charge is adsorbed with low-calcium fly ash particles by electrostatic adsorption;
(3) continuously introducing industrial waste gas containing CO₂ and water vapor into the rotary packed bed, controlling the flow rate to be 4 L/min, and starting the rotating device, where the rotating speed is 500 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the supplementary cementitious material based on electrostatic adsorption for high-efficiency CO₂ sequestration.

### Embodiment 7

A preparation method of a supplementary cementitious material based on electrostatic adsorption for high-efficiency CO₂ sequestration, which includes the following steps:
(1) oven drying and grinding carbide slag to obtain ultrafine carbide slag powder with 2500 meshes, and placing the ultrafine carbide slag powder in an electrostatic field generated by a discharge mechanism to make it electrostatically charged to obtain ultrafine carbide slag powder with electrostatic charge;
(2) mixing low-calcium fly ash (150-500 meshes) with the ultrafine carbide slag powder with electrostatic charge in a mixer for 5 min, making the carbide slag uniformly attached to the surface of the fly ash, where the mass ratio of the low-calcium fly ash to the ultrafine carbide slag powder with electrostatic charge is 70:30, and the mixture enters a rotary packed bed through a feed port, and the ultrafine carbide slag powder with electrostatic charge is adsorbed with low-calcium fly ash particles by electrostatic adsorption;
(3) continuously introducing industrial waste gas containing CO₂ and water vapor into the rotary packed bed, controlling the flow rate to be 4 L/min, and starting the rotating device, where the rotating speed is 500 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the supplementary cementitious material based on electrostatic adsorption for high-efficiency CO₂ sequestration.

### Comparative Embodiment 1

A preparation method of a cementitious material includes the following steps:
(1) drying and grinding carbide slag to obtain ultrafine carbide slag powder with 2500 meshes;
(2) mixing low-calcium fly ash (150-500 meshes) and ultrafine carbide slag powder in a mixer for 5 min to mix evenly, where the mass ratio of the low-calcium fly ash to the ultrafine carbide slag powder is 80:20, and the mixture enters a rotary packed bed through a feed inlet;
(3) continuously introducing industrial waste gas containing CO₂ and water vapor into the rotary packed bed, controlling the flow rate to be 4 L/min, and starting the rotating device, where the rotating speed is 500 r/min, the temperature is controlled to be 25° C., and the pressure is controlled to be 0.1 MPa; and
(4) after 10 min of reaction, allowing the reacted slurry to flow out from the bottom of the reactor into a collection vessel and the gas to be discharged from the top of the rotating packed bed, pumping and filtering and drying the reacted slurry to obtain the cementitious material.

### Test Embodiment 1

The CO₂ sequestration capacity of the cementitious materials prepared in Embodiments 1-7 and Comparative embodiment 1 is tested, and the test results are shown in Table 1 below. The CO₂ sequestration capacity of cementitious materials is obtained by thermogravimetric analyzer. At 600° C.-800° C., CaCO₃ produced by carbonization is decomposed into CaO and CO₂, and the CO₂ sequestration capacity is obtained by weight loss.

TABLE 1
CO₂ sequestration capacity of cementitious materials prepared
in Embodiments 1-7 and Comparative embodiment 1

| | Mesh of calcium | Rotating | Sequestration |
|---|---|---|---|
| Implementation | carbide | speed | amount of |
| embodiments | slag(meshes) | (r/min) | CO₂ (g/kg) |
| Embodiment 1 | 1000 | 300 | 111.65 |
| Embodiment 2 | 1000 | 400 | 112.57 |
| Embodiment 3 | 1000 | 500 | 114.45 |
| Embodiment 4 | 1500 | 500 | 120.94 |
| Embodiment 5 | 2000 | 500 | 123.82 |
| Embodiment 6 | 2500 | 500 | 125.94 |
| Embodiment 7 | 2500 | 500 | 129.56 |
| Comparative | 2500 | 500 | 72.35 |
| embodiment 1 | | | |

### Test Embodiment 2

The standard mortar mechanical properties of cementing materials prepared in Embodiments 1-7 and Comparative embodiment 1 are tested, and the test results are shown in Table 2 below. Experimental conditions: 135 g of cementitious materials and 315 g of P.I42.5 cement are used as the cementitious system, and are mixed and stirred with 225 g of water and 1350 g of ISO sand according to Technical Code for Application of Mineral Admixture (GB/T51003-2014). According to Test Method of Cement Mortar Strength (ISO Method) (GB/T17671-2021), after demoulding, the specimen is cured in water at 20° C.±1° C. for 28 days.

At the same time, the control group is set up, namely:
Low-calcium fly ash/P.I 42.5 cement group:
135 g of low-calcium fly ash (the composition is the same as the above embodiments) and 315 g of P.I 42.5 cement are mixed to be used as the cementitious system; other experimental methods are the same as above, and the compressive strength of 28 d is tested.

P.I 42.5 cement group: 450 g of P.I 42.5 cement is used as the cementitious system; other experimental methods are the same as above, and the compressive strength of 28d is tested.

TABLE 2
Standard mortar mechanical properties of cementitious materials
prepared in Embodiments 1 to 7 and Comparative embodiment 1

| | Compressive strength |
|---|---|
| Implementation embodiments | of 28d (MPa) |
| Embodiment 1 | 39.9 |
| Embodiment 2 | 40.5 |
| Embodiment 3 | 40.8 |
| Embodiment 4 | 41.4 |
| Embodiment 5 | 42.2 |
| Embodiment 6 | 44.2 |
| Embodiment 7 | 45.0 |
| Comparative embodiment 1 | 37.1 |
| Low-calcium fly ash/P.I 42.5 cement group | 34.3 |
| P.I 42.5 cement group | 44.6 |

### Test Embodiment 3

The water requirement of normal consistency and initial and final setting time of cementitious materials prepared in Embodiments 1-7 and Comparative embodiment 1 are tested, and the test results are shown in Table 3 below. Experimental conditions: 150 g of cementitious material and 350 g of P.I 42.5 cement are mixed as the cementitious system, and the water requirement of normal consistency is obtained by testing according to Test Methods for Water Requirement of Normal Consistency, Setting Time and Soundness of the Portland Cement (GB/T1346-2011), and the initial setting time and final setting time of cementitious material are obtained according to the water requirement of normal consistency.

At the same time, the control group is set up, namely:
Low-calcium fly ash/P.I42.5 cement group: 150 g of low-calcium fly ash (the composition is the same as the above embodiments) and 350 g of P.I 42.5 cement are mixed to be used as the cementitious system; other experimental methods are the same as above, and the water requirement of normal consistency and the initial and final setting time are tested.

P.I42.5 cement group: 500 g of P.I42.5 cement is used as the cementitious system; other experimental methods are the same as above, and the water requirement of normal consistency and the initial and final setting time are tested.

TABLE 3
Water requirement of normal consistency and initial and
final setting time of cementitious materials prepared
in Embodiments 1 to 7 and Comparative embodiment 1

| | Water Requirement | Initial | Final |
|---|---|---|---|
| Implementation | of Normal | setting | setting |
| embodiments | Consistency (%) | time (min) | time (min) |
| Embodiment 1 | 26.6 | 145 | 210 |
| Embodiment 2 | 26.9 | 141 | 200 |
| Embodiment 3 | 27.8 | 138 | 197 |
| Embodiment 4 | 28.0 | 131 | 191 |
| Embodiment 5 | 28.6 | 124 | 184 |
| Embodiment 6 | 29.2 | 119 | 180 |
| Embodiment 7 | 29.8 | 114 | 176 |
| Comparative embodiment 1 | 32.5 | 153 | 220 |
| Low-calcium fly ash/P.I | 25.5 | 225 | 305 |
| 42.5 cement group | | | |
| P.I 42.5 cement group | 26.0 | 115 | 180 |

The specific embodiments of the present disclosure described above do not limit the scope of protection of the present disclosure. Any other corresponding changes and deformations made according to the technical concept of the present disclosure should be included in the protection scope of the claims of the present disclosure.

What is claimed is:

1. A preparation method of a supplementary cementitious material based on electrostatic adsorption for high-efficiency CO₂ sequestration, comprising steps of:
(1), placing ultrafine carbide slag powder into an electrostatic field to make the ultrafine carbide slag powder have electrostatic charge, and obtaining ultrafine carbide slag powder with electrostatic charge; and
(2), uniformly mixing low-calcium fly ash and the ultrafine calcium carbide slag powder with electrostatic charge, followed by adding into a rotary packed bed; continuously introducing industrial waste gas containing CO₂ and water vapor into the rotary packed bed; after a reaction, collecting a material and drying to obtain the supplementary cementitious material based on electrostatic adsorption for high-efficiency CO₂ sequestration.

2. The preparation method of the supplementary cementitious material based on electrostatic adsorption for high-efficiency CO₂ sequestration according to claim 1, wherein a step (1) comprises one or more of following conditions:
i: a particle size of the ultrafine carbide slag powder is 1000-2500 meshes; and the ultrafine carbide slag powder is prepared by drying and grinding carbide slag;
ii: the ultrafine carbide slag powder comprises following components in parts by mass: 86.26-89.21 parts of CaO, 3.12-5.41 parts of SiO₂, 4.01-6.75 parts of SO₃, 1.39-2.27 parts of Al₂O₃ and 0.21-1.97 parts of MgO.

3. The preparation method of the supplementary cementitious material based on electrostatic adsorption for high-efficiency CO₂ sequestration according to claim 1, wherein in a step (2), a particle size of the low-calcium fly ash is 150-500 meshes.

4. The preparation method of the supplementary cementitious material based on electrostatic adsorption for high-efficiency CO₂ sequestration according to claim 1, wherein in the step (2), the low-calcium fly ash comprises following components in parts by mass: 2.32-3.76 parts of CaO, 44.01-57.89 parts of SiO₂, 23.24-31.34 parts of Fe₂O₃, 2.27-5.15 parts of Fe₂O₃ and 0.63-3.97 parts of MgO.

5. The preparation method of the supplementary cementitious material based on electrostatic adsorption for high-efficiency CO₂ sequestration according to claim 1, wherein in the step (2), a mass ratio of the low-calcium fly ash to the ultrafine carbide slag powder with electrostatic charge is 60-90:10-30.

6. The preparation method of the supplementary cementitious material based on electrostatic adsorption for high-efficiency CO₂ sequestration according to claim 1, wherein in the step (2), a continuous flow rate of industrial waste gas containing CO₂ and water vapor is 3-5 L/min.

7. The preparation method of the supplementary cementitious material based on electrostatic adsorption for high-efficiency CO₂ sequestration according to claim 1, wherein in the step (2), the industrial waste gas containing CO₂ and water vapor comprises following components in percentage by volume: 9-10% of water vapor, 25-26% of CO₂ and 60-61% of nitrogen; wherein the industrial waste gas containing CO₂ and water vapor comprises following components in percentage by volume: 9.6% of water vapor, 25.4% of CO₂ and 60.5% of nitrogen.

8. The preparation method of the supplementary cementitious material based on electrostatic adsorption for high-efficiency CO₂ sequestration according to claim 1, wherein in the step (2), a reaction duration is 5-15 min; a rotating speed of the rotary packed bed is 300-500 r/min; a temperature of the rotary packed bed is 20-30° C. and a pressure is 0.05-0.5 MPa.

9. A supplementary cementitious material based on electrostatic adsorption for high-efficiency CO₂ sequestration prepared by the preparation method according to claim 1.

10. A use method of the supplementary cementitious material based on electrostatic adsorption for high-efficiency CO₂ sequestration according to claim 9, comprising following steps:
compounding the supplementary cementitious material based on electrostatic adsorption for high-efficiency CO₂ sequestration with cement, followed by applying in concrete and mortar; wherein a mass ratio of the supplementary cementitious material based on electrostatic adsorption for high-efficiency CO₂ sequestration to cement is 20-40:60-80.
